(19) United States
(12) Patent Application Publication
(10) Pub. No.: US 2007/0089752 A1
(43) Pub. Date: Apr. 26, 2007

(54) TISSUE STRETCHING DEVICE

(75) Inventor: Robert W. Christensen III, Arvada, CO (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: CRANIOMANDIBULAR REHAB, INC., Denver, CO (US)

(21) Appl. No.: 11/551,565

(22) Filed: Oct. 20, 2006

Related U.S. Application Data
(60) Provisional application No. 60/729,407, filed on Oct. 21, 2005.

(51) Int. Cl. A61G 15/00

(52) U.S. Cl. 128/845

(57) ABSTRACT

A tissue stretching device includes a first and second mouthpiece. Each mouthpiece includes a bite area, an extension bar, and an interface area. The bite area is shaped to match the general curvature of a set of teeth. The interface area has a raised body. The extension bar is positioned between the bite area and the interface area. A connecting assembly is linked to the interface area of the first mouthpiece and the second mouthpiece and arranged to couple the first mouthpiece inline with the second mouthpiece. The second mouthpiece is positioned in an inverted position relative to the first mouthpiece to place the raised body of the first and second mouthpieces in opposing directions. The connecting assembly includes an elongate member. At least one of the first and second mouthpieces is able to be positioned along the elongate member relative to the other mouthpiece.

### CROSS-REFERENCE TO RELATED APPLICATIONS

This application is a continuation of U.S. Provisional Application No. 60/729,407 filed Oct. 21, 2005, which is hereby incorporated by reference in its entirety.

### BACKGROUND OF THE INVENTION

1. Field of Invention

This invention generally relates to a device for treating the jaw, teeth and face. More specifically, the invention relates to a tissue stretching device.

2. Discussion of Related Art

Medical practitioners for many years have been asked to help patients regain range and motion in constrained joints of the body where tissues like skin, tendons, joint, scar, ligament, and muscle can impede the patient from a full range-of-motion (ROM). Devices and methods of helping patients achieve full ROM have included self-directed exercise, assisted stretching and exercises, forced manipulation, surgery, and splints. However, stretching the jaw and treatment of temporomandibular joint (TMJ) is limited by the size of the opening of a patient's mouth and the location where a treatment can take place. User and assisted stretching are complicated by the lack of good grip locations. Self-directed exercises are often inadequate as the activated muscles can cause pain, restrict the ability to open the jaw, and are not capable of overcoming fibrous tissues that hold the jaw closed.

Self and assisted stretching requires the user to insert his or her hands into the patients mouth with little support and protection for the patient. Physical therapy is thus often limited to massage and teaching the patient self-directed exercises to stretch the jaw opening. For these reasons, self-directed and assisted exercises are recommended with reservations, and provide little or no help to patients with restrictive tissue that cannot be lengthened without surgery or anesthetized doctor-assisted manipulation.

Over the last generation, two manual jaw-stretching devices have been nationally distributed to assist patients: the Therabite device as discussed in U.S. Pat. No. 5,035,420 and the EZ-Flex device as discussed in U.S. Pat. No. 5,562,105. These two devices basically work as extensions that are inserted into the mouth to provide assisted stretching for the patient.

In the '420 patent, the device is a manually driven jaw spreader, where the patient squeezes down on a large device body, pressing two mouth plates apart, to spread the patients jaw. The device has a long body that is bulky with an unwieldy number of parts and settings, including weak mouthpiece plates and a non-customized curved track that does not correspond to an individual's unique jaw motion. Further, the design requires a significant opening for the patient's mouth, usually at least 10 mm or more, which excludes the most in-need, severely limited patients.

The device in the '105 patent includes two reservoirs. One reservoir is has a fluid that is squeezed to pump the fluid into the other reservoir. When the fluid is pumped into the other reservoir it pushes two hinged plates apart to open the jaw. It is difficult with this design to provide a tube and reservoir rigid enough to accommodate the pressure required to push apart the two hinged plates. This low pressure makes the device incapable of stretching severely limited patients and cannot override muscle spasms. The design is disadvantageous because the fluid system is susceptible to leaking, the shape of the two plates covers a very small area of the teeth, and a user has no way of measuring the opening. Furthermore, the hand-pressed reservoir is small and uncomfortable over prolonged use, and the hinge opens in an arc pattern that is opposite to the opening of the jaw.

Both of these devices are controlled by the pressure of the hand which limits stretching to the patient's coordination and strength to provide passive motion to the joint. Furthermore, they cannot sustain a consistent opening like a splint.

The treatment of jaw temporomandibular joint has not had the benefit of a device to provide good splint therapy. The need for a dynamic splint to remain in place limits their use in the mouth and jaw. It has also been theorized that the continuous pressure of the dynamic splint stresses the tissues and joint without relief, thus slowing the process of stretching. A number of devices resemble dynamic splints for the mouth and jaw. These devices, often used in treating patients in jaw exercises, were primarily devised to tone the facial and jaw muscles, some examples include U.S. Pat. No. 3,721,439, and U.S. Pat. No. 3,138,096. These devices have been developed for training the orofacial muscles and are often bulky, uncomfortable and painful for patients with restricted joint motion.

U.S. Pat. No. 6,361,475 describes another jaw exerciser utilizing a tube structure to press two mouthpieces and the jaw apart. Instead of user supplied force, and adding elastic bands, this device can further allow a user to exercise their face by resisting against biting down to conditioning the facial muscles. This device is unnecessarily large and the hand-grips are poorly positioned parallel in front of the chin making them hard to squeeze.

Before these devices were available or as an alternative to these devices, patients use tongue blades, i.e. tongue depressors to stretch their jaw. Using this method, the patient places a stack of wooden tongue-blades between the teeth. They progressively insert additional blades into the stack, tapping them in to slowly increase the height of the stack, which presses the teeth apart. This is the most common prescribed therapy for patients of trismus, not because of its effectiveness but from the lack of other options. Tongue-blades are ineffective, uncomfortable, unpadded, and often damage the teeth.

Other specula devices are designed for animals and dental mouth props. These devices hold a mouth open for access by a handler, medical or dental professional, while working inside the mouth. One example is the Obwegeser mouth opener including a prop made of a drive screw with two guide rods that press two thin metal bars apart to hold the mouth open. The Obwegeser mouth opener has a very thin bar that lacks necessary occlusive area to prevent pain and teeth damage over long-term use, and has a small, flat head on the screw post making self-use more difficult. U.S. Pat. No. 5,718,665 discloses a horse prop with a drive screw and a guide rod hinged to two teeth plates and held in place with a head strap. This horse prop is too large for human use, is not shaped to avoid the tongue, and includes hinges and a head strap that are superfluous to human use. Furthermore, being designed and intended as specula and not therapeutic equipment, both devices lack dentition retention rails, unnecessarily use a support rod to hold the teeth plates straight, lack the structure for easy holding of the device by a user, and have small or no drive-screw handles.

The subject matter claimed herein is not limited to embodiments that solve any disadvantages or that operate only in environments such as those described above. Rather, this background is only provided to illustrate one exemplary technology area where some embodiments described herein may be practiced.

### SUMMARY OF THE INVENTION

In accordance with the present invention, a tissue stretching device includes a first and second mouthpiece. Each mouthpiece includes a bite area, an extension bar, and an interface area. The bite area is shaped to match the general curvature of a set of teeth. The interface area has a raised body. The extension bar is positioned between the bite area and the interface area. A connecting assembly is linked to the interface area of the first mouthpiece and the second mouthpiece and arranged to couple the first mouthpiece inline with the second mouthpiece. The second mouthpiece is positioned in an inverted position relative to the first mouthpiece to place the raised body of the first and second mouthpieces in opposing directions. The connecting assembly includes an elongate member. At least one of the first and second mouthpieces is able to be positioned along the elongate member relative to the other mouthpiece.

These and other features of the present invention will become more fully apparent from the following description and appended claims, or may be learned by the practice of the invention as set forth hereinafter.

### BRIEF DESCRIPTION OF DRAWINGS

In order to more fully understand the manner in which the above-recited and other advantages and objects of the invention are obtained, a more particular description of the invention will be rendered by reference to specific embodiments thereof which are illustrated in the appended drawings. Understanding that these drawings depict only typical embodiments of the invention and are not therefore to be considered as limiting of its scope, the invention will be described and explained with additional specificity and detail through the use of accompanying drawings.

FIG. 1 is a perspective view of an embodiment of the tissue stretching device.

FIG. 2 is an exploded view of the tissue stretching device of FIG. 1.

FIG. 3 is a side view of the tissue stretching device of FIGS. 1 and 2 showing alternative positions.

FIG. 4 is a side view of the inner components of the tissue stretching device in accordance with an embodiment of the present invention.

FIG. 5 is a perspective view of another embodiment of the invention including handles.

FIG. 6 is a side view of a further embodiment of the present invention having a flexible or curved connecting member.

FIGS. 7 and 8 are perspective illustrations of additional embodiments of the device.

### DRAWING REFERENCE NUMERALS

1 Tissue Stretching Device
2 Mouthpiece
4 Mouthpiece
6 Bite Area
8 Extension Bar
10 Interface Area
12 Curved Occlusal Area
14 Palatal Rail
16 Labial Rail
18 Occlusal Padding
20 Threaded Bore
22 Body Features
24 Pivot Ball
26 Vertical Element Catch
28 Shaped Void
30 Position
32 Curved Bore
34 Raised Body
38 Elongate Member
40 Vertical Element
42 Connecting Assembly
44 Top
46 Rod
48 Notch
50 Threading
52 Clip Fastener
54 Element Fastener
56 Shaped Element
58 Curved Element
60 Notched Element
62 End
78 Second Handle
80 Finger Loops
82 Element Catch
84 Support Catch
86 Spring
88 Compression Band
90 Horizontal Threaded Bore
92 Set Screw
94 Set Screw Knob
98 Ratchet Arm
100 Ratchet Clip
102 Release
104 Torsion Hinge
108 Horizontal Bore
110 Pinion Gear
112 Pinion Knob
120 Case Assembly
122 Body Sides
124 Upper Cap
126 Lower Cap
128 Body Filler Bar
130 Cap Hooks
132 Cap Clips
134 Cap Support Bar
136 Clip Release Holes
138 Cap Support Notch
140 Pivot Sockets
142 Body Filler Slot
144 Knob Aperture
146 Distance Marks
148 Position Marker
150 Position Sliding Marker First Handle

### DETAILED DESCRIPTION OF EXEMPLARY EMBODIMENTS

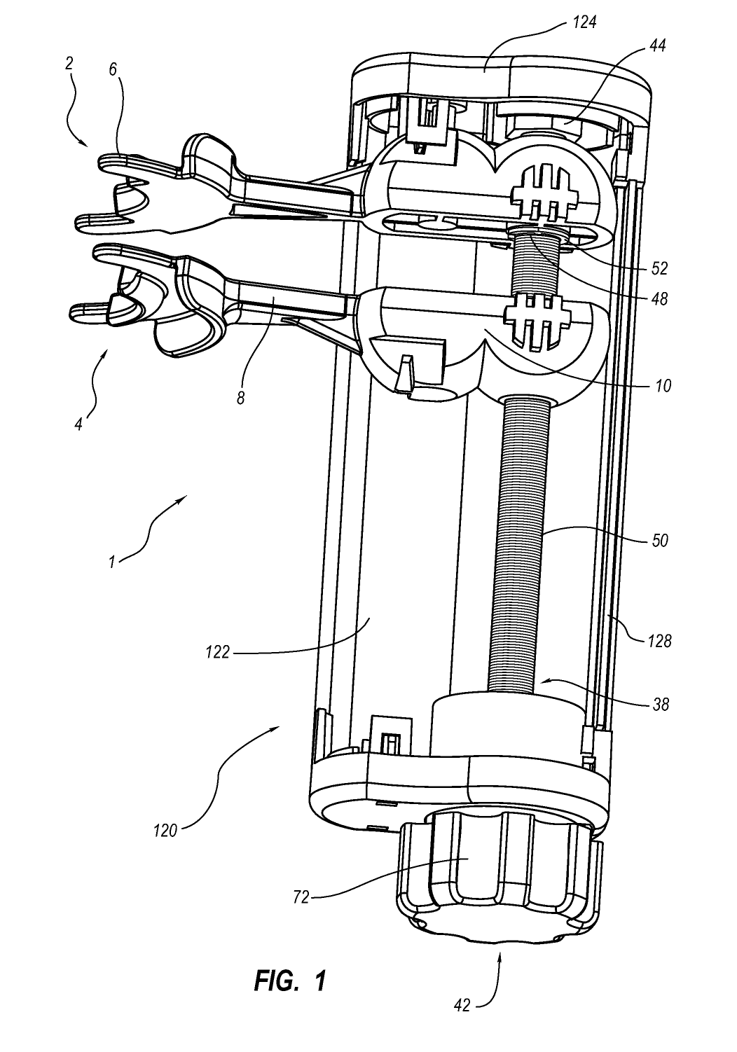

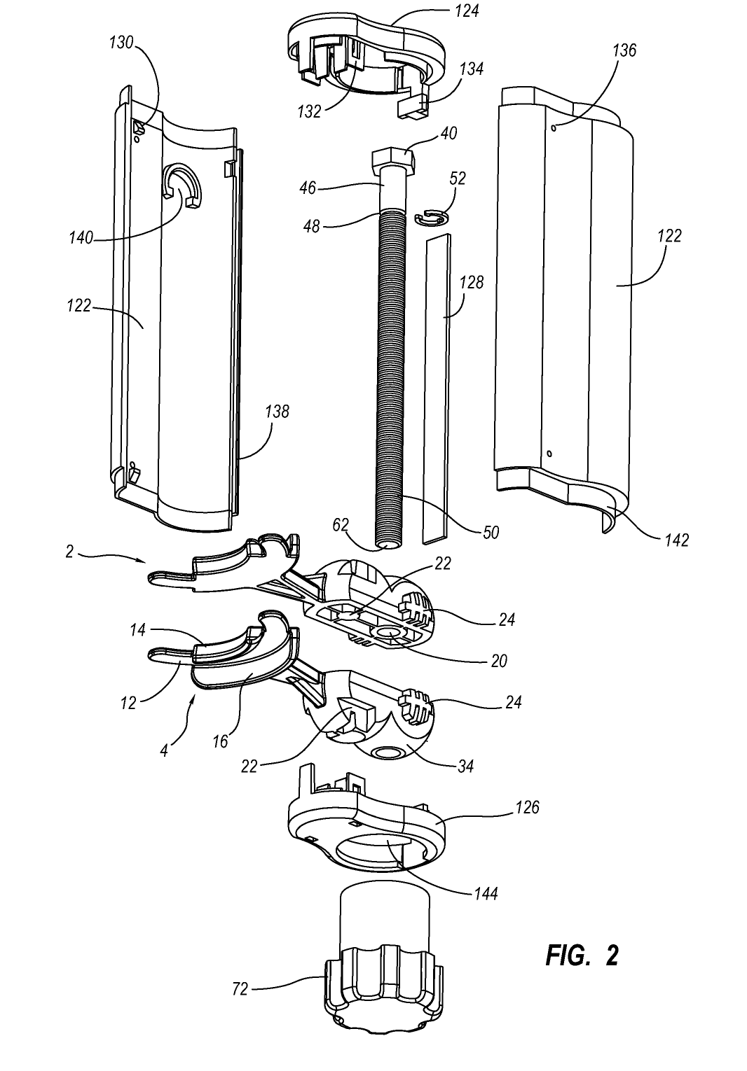

The present invention relates to a tissue stretching device 1. The various embodiments of the present invention will now be discussed with respect to the accompanying drawings. In FIGS. 1 and 2, an exemplary embodiment of the device 1 is illustrated with two mouthpieces 2 and 4, one being placed in an inverted position relative to the other and positioned inline with each other along a connecting assembly 42, and surrounded by a case assembly 120.

FIG. 1 shows a perspective view of one exemplary embodiment with one body side 122 shown and another side removed to simplify the discussion and show the internal workings of the embodiment. FIG. 2 shows an exploded view of the embodiment in FIG. 1 with additional details of the parts. The first or upper mouthpiece 2 and second or lower mouthpiece 4 have three main sections-a bite area 6, an extension bar 8, and an interface area 10—with a total length, for example, between about 10 mm and about 200 mm. While the mouthpieces are referred to as first and second or upper and lower mouthpieces, it will be understood by one skilled in the art that these two mouthpieces can be interchanged and that the terms used to describe the mouthpieces are not limited to one particular position in the tissue stretching device 1. Extending out from the back of the bite area 6 is the extension bar 8, which attaches to the interface area 10. The extension bar 8 is positioned between the bite area 6 and the interface area 10.

In the exemplary embodiment, the bite area 6 has a width of about 50 mm, and could be between about 20 mm and about 80 mm. The bite area 6 includes features like a flat, curved occlusal area 12 having a thickness of about 1.5 mm and can be between about 0.01 mm and about 10 mm. The bite area 6 is shaped to match the general curvature of a set of teeth to receive an average curvature, or bite pattern, of a user's teeth. A raised retention structure can be placed on the bite area of each of the mouthpieces 2 and 4. The raised retention structure includes retention members, such as a palatal rail 14 and a labial rail 16, which rise up about 4 mm to about 6 mm, and can have height of about 0.01 mm to about 15 mm from the occlusal area.

The extension bar 8 protrudes out the back of the bite area 6 being of a width from about 1 mm to full width of the bite area, having a height equal to or less than that of the bite area. The shape of the extension bar 8 in the exemplary embodiment is of a horizontal triangle connected across about 10 mm of the bite area 6 and intersects with a vertical triangle connecting across about 10 mm of the interface area 10, both triangles having a thickness of about 4 mm; but the extension bar can have any predetermined shape designed to work with all assemblies, having a length between about 5 mm and about 100 mm.

The interface area 10 includes a raised body 34, which can include attributes including shaped bores or voids 28 like a threaded bore 20 or a vertical element catch 26, a pivot ball 24, and other body features 22 like extrusions or notches. The raised body 34 provides many benefits, for example, including additional material and volume to attach various components for moving, stabilizing, and manipulating the mouthpieces 2 and 4. The raised body 34 is shaped to allow the other components to be easily adapted to the mouthpieces 2 and 4. The volume of the raised body 34 adds surface area to the body features 22 to increase friction and strength at the connection points between the mouthpieces 2 and 4 and other components. These connections are discussed in more detail below. In the exemplary embodiment, the raised body 34 is about 35 mm long, about 15 mm high and about 15 mm wide, with the pivot balls 24 extending out about 4 mm from each side. The raised body 34 has a shape of two spheres flattened, or cut on the top, bottom and both sides, with various body features 22 and bores 20. The raised body 34 can also be of any predetermined shape and size necessary for a given embodiment. The interface area 10 in the mouthpieces 2 and 4 of the exemplary embodiment have a threaded bore 20 to fit ¼-20 threading, and can be of a predetermined size to fit a threaded rod between 4-40 and 1-8.

The connecting assembly 42 links the interface area 10 of the first mouthpiece 2 to the second mouthpiece 4 and is arranged to couple the first mouthpiece 2 inline with the second mouthpiece 4. The second mouthpiece 4 is positioned in an inverted position relative to the first mouthpiece 4 to place the raised body 34 of the mouthpieces 2 and 4 in opposing directions. At least one of the mouthpieces 2 and 4 can be positioned along the elongate member 38 relative to the other mouthpiece. In this exemplary embodiment, the connecting assembly 42 includes an elongate member 38 that can be vertical, shaped, curved, threaded, notched, or the like. For example, the elongate member 38 can include a vertical element 40 having a bar or rod 46 that is about 100 mm long and about 5 mm wide, and a knob 72 that is about 35 mm tall and about 30 mm wide at a grip of the knob 72. The rod 46 has a top 44 at one end 62. Below the top 44 is a notch 48 about 15 mm down from the top and threading 50 of size ¼-20 extending from the notch to the end. The threading on the rod and in the bore can be of any type and size of thread or ribbon known to one skilled in the art. A clip fastener 52 is sized to fit into the notch 48, which cuts about 0.5 mm into the rod and can be of a predetermined depth up to the radius of the rod 46. The first or upper mouthpiece 2 is positioned between the top 44 and the notch 48. The clip fastener 52 is inserted into the notch 48, and holds the mouthpiece 2 in place along the rod 46 at the raised body 34. The second or lower mouthpiece 4 at its raised body 34 is located along threading 50 in the rod 46 below the notch 48. The knob 72 is attached to the end 62 of the rod 46, which screws onto the threading 50 and grips the rod 46.

Surrounding the interface areas 10 of the mouthpieces 2 and 4 and the connecting assembly 42 is case assembly 120. The case assembly 120 includes two body sides 122, an upper cap 124, and a lower cap 126. The two body sides 122 interlock with the two caps 124 and 126. The body sides have cap hooks 130 that extend out from the inside of the body sides 122. These hooks 130 snap into cap clips 132 on the upper cap 124 and lower cap 126. Additionally, clip release holes 136 are placed on the body sides 122 to coincide with the engaged cap clips 132. At the back of each of the caps 124 and 126 is a cap support bar 134, which fits into a cap support notch 138 along the edge of the body sides 122. Closing the space between the two body sides 122 in the rear of the device 1 is a body filler bar 128, which fits into a body filler slot 142 along the body sides 122 and can be fastened into place. The shape of the case assembly 120 in the exemplary embodiment is curved around the internal elements with a flat top and bottom. The upper cap 124 is closed across the top. The lower cap 126 has a knob aperture 144 where the elongate member 38 extends through to attach the knob 72 on the exterior side of the case assembly 120. The case assembly is shaped to enclose at least a portion of the mouthpieces 2 and 4 and the connecting assembly 42. The case assembly can include a slot to allow a portion of the mouthpieces 2 and 4 to extend out from the case assembly through the slot. The slot can be arranged to guide the mouthpieces 2 and 4 relative to each other.

The case assembly 120 has a height of about 110 mm, with the body sides 122 being about 95 mm and each cap extending out beyond the body sides 122 about 7.5 mm. The case assembly 120 is about 30 mm wide and 40 mm long. The size of the case assembly 120 can be from about 25 mm to any length to adequately enclose the vertical connecting assembly 42, and can be of any shape fully or partially surrounding the vertical element 40. In this embodiment, the case assembly 120 wraps around the mouthpiece interface areas 10 with the upper mouthpiece's pivot ball 24 sitting within the pivot sockets 140 on the body sides 122. The body filler bar 128 sits between the two body sides 122 held in the body filler slot 142, is about 8 mm wide, about 2 mm thick, and about 80 mm tall.

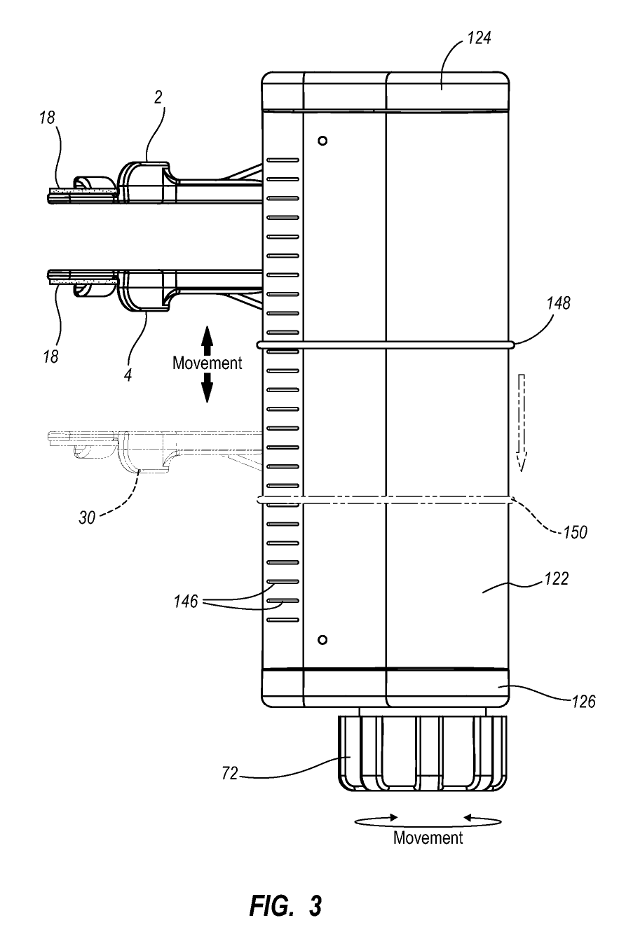

FIG. 3 shows side view of the exemplary embodiment illustrated in FIGS. 1 and 2 with distance marks 146 displayed along the one or both body sides 122. The distance marks 146 can be arranged on the body sides 122 by notching, etching, painting, embossing, adhering, or otherwise placing indicia along the sides to designate the distance between the mouthpieces 2 and 4. The distance marks 146 are about 3 mm apart, and can be distanced between about 1 mm and about 25 mm apart. A position marker 148 can also be included to help locate the position of the mouthpieces. The position marker 148 is configured to wrap around the body sides 122 and is about 3 mm tall, and can be between about 1 mm and about 20 mm tall. FIG. 3 also shows occlusal padding 18 adhered along the bite areas of the mouthpieces 2 and 4. The padding can be about 3 mm thick. The occlusal padding 18 may be of any material soft and suitable for the mouth, including foams, felts, plastics or any other material known to one skilled in the art; and the padding can be attached by any means suitable within the mouth like an adhesive or chemical bonding.

The holes 136 are positioned in the body sides 122 next to the cap hooks 130 to allow a user to insert a pin, rod, or wire into the inside of the case assembly 120 to push the cap clips 132 off the cap hooks 130 to release or disengage the caps from the body sides. When the cap hooks 130 are disengaged from the cap clips 132, the body sides 122 can be removed to gain access to the connecting assembly 42.

In the exemplary embodiment, the vertical element 40 includes threaded rod 46 that can be made of stainless steel. The other parts can be made of hard plastic like ABS, polycarbonate, nylon, or polyurethane, with the mouthpieces being made of a material suitable for use in a patient's mouth. These parts, including the rod, also can be made of a material such as plastic, laminated fibrous materials, other plasticized materials, wood, metal, or any other material known to one skilled in the art that is sufficiently stiff and safe for use in the mouth for their specific function in the tissue stretching device 1. The connecting member can also be made of a coil or other flexible material to be curved or to bend with the pressure on the mouthpieces to better match a user's jaw motion.

This embodiment of the tissue stretching device 1 works by controllably moving and holding the two mouthpieces 2 and 4 apart from each other along the vertical element connecting assembly 42. The device 1 is employed by first inserting the bite areas 6 into the user's mouth, with the teeth resting against the curved occlusal areas 12 of both mouthpieces and between the palatal rail 14 and labial rail 16. The mouthpieces are shaped to avoid the user's tongue with a cutout or void. Occlusal padding 18 is made of a pad material, which may be placed along the bite area and is used to cushion the pressure on the user's teeth and to deform under the teeth to help hold the mouthpieces in place on the teeth. The two rails additionally act as retentive barriers to help prevent the device 1 from slipping from the mouth. The case assembly 120 in this embodiment acts as a body for the user to grip the device 1. The two body sides 122 further hold the mouthpieces 2 and 4 in vertical alignment.

After inserting the device 1 into the mouth, the knob 72 can be turned to rotate the rod 46. As the rod 46 is turned, the mouthpiece 4 moves along the threads 50 of the rod 46 relative to the mouthpiece 2. The rod 46 rotates freely within the mouthpiece 2. The mouthpiece 2 is attached to the rod 46 by a clip fastener 52 in a rod notch 48 and also by the pivot balls 24 in the pivot sockets 140 of the case assembly 120. The mouthpiece 4 moves up or down the threads 50 and towards or away from the mouthpiece 2 based on the direction of the rotation. As the mouthpiece 4 moves down the rod 46, the position marker 148 is pushed down the body. The position marker 148 thus acts to record the distance that the mouthpieces 2 and 4 are opened by the user, and can be compared with the distance marks 146 for an approximate measurement. FIG. 3 shows this movement along various positions 30 of the mouthpiece 4 and the position sliding marker 150 when the knob is turned.

With the expanding distance between the mouthpieces 2 and 4, the user is able to stretch or push the jaw open by rotating the knob 46 in a first direction. When the user stops turning the knob 72 the lower mouthpiece stops moving along the rod 46 and retains its position, allowing the user to maintain a consistent stretch over extended periods. After the user holds a stretch for a predetermined time, the user can remove the device 1 by turning the knob 72 in a second direction to draw the mouthpiece 4 back toward the mouthpiece 2. By bringing the mouthpieces 2 and 4 closer together, the user can remove the device 1 from between the teeth. Alternatively, the threading of the mouthpieces 2 and 4 and rod 46 could be of a thread or form, which does not or selectively holds the position of the mouthpieces 2 and 4, allowing the mouthpieces 2 and 4 to turn the rod 46 and move back together under any or a predetermined pressure of the user's mouth.

An alternative embodiment can include a rod 46 having surface features like threading on the rod and both of the mouthpieces 2 and 4 having shaped bores to match the features of the rod 46. The rod can include left hand threads on one side and right hand threads on the other. When the rod is turned, the mouthpieces move in opposite directions along the rod 46. This configuration can increase the speed in which the mouthpieces move relative to each other. The mouthpieces 2 and 4 would be placed in the middle of a rod 46 in a start position and as the rod is turned, the two mouthpieces would move away from each other to open and close the device 1 and user's jaw.

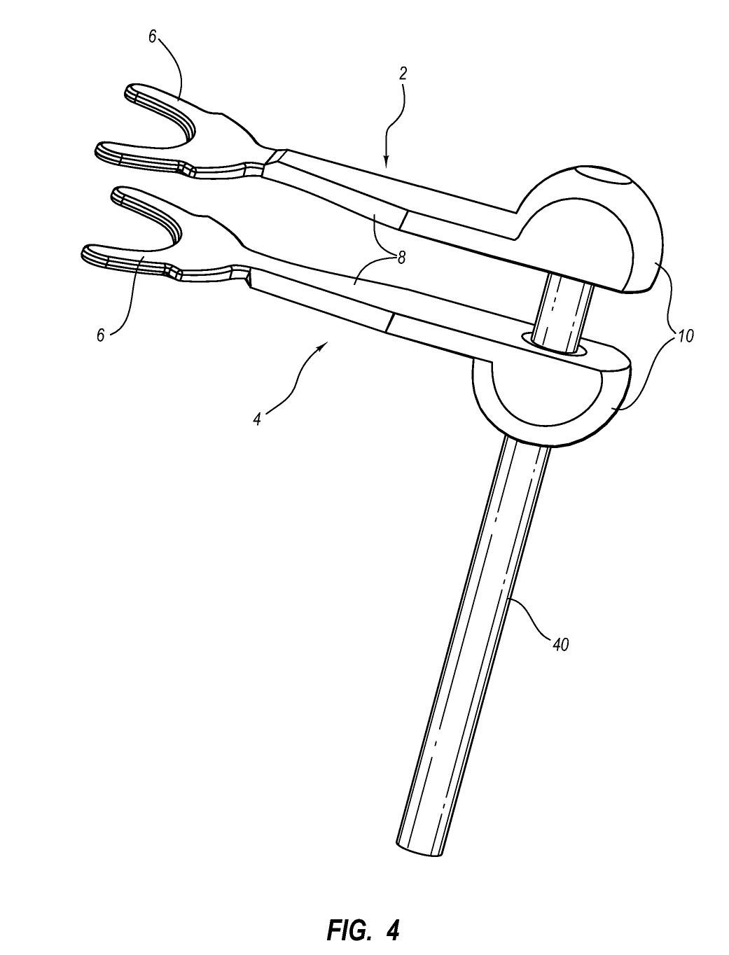

FIG. 4 depicts the inner components of the tissue stretching device 1. The inner components include three main components: the mouthpieces 2 and 4, and the vertical element 40. The mouthpieces 2 and 4 of this embodiment have a simple bite area 6, an extension bar 8 and a simple interface area 10 with a single shaped void. For use, the mouthpieces 2 and 4 can be moved by the user along the vertical element 40. The pressure of the teeth on the bite areas 6 can angle the mouthpieces 2 and 4 on the vertical element 40 to hold their position with friction or an interlocking structure for a sustained stretch. A friction fit structure can be provided between the interface area 10 of the mouthpieces 2 and 4 and the connecting assembly 42. The friction fit structure, for example, can include a tight tolerance, a threaded interface, or other friction coupling between the elongate member 38 and the shaped void 28 of the raised body 34. For instance, the tolerance between the shaped void 28 and the elongate member 38 can be set to allow the mouthpiece member to move up and down the elongate member 38 when little or no force is applied to the bite area 6, and resist movement when a force is applied to the bite area 6. In this example, a set distance is maintained between the mouthpieces 2 and 4 from the friction between the shaped void 28 and the elongate member 38 when a user's jaw tissues are being stretched. In another example, the friction fit structure can include threads formed along the elongate member 38.

From the embodiment, the vertical element 40 can be enhanced as part of a connecting assembly 42. The connecting assembly 42 is the collection of parts used to link the mouthpieces 2 and 4 and to provide a system for them to be moved. A positioning assembly 70 can be added to the basic embodiment, and works to move and sometimes hold the mouthpieces' position to stretch the jaw muscles and tissue of a user. The basic embodiment can be further augmented with the case assembly 120. Some purposes of the case assembly 120 can be to act as a support for the mouthpieces, to provide a body for the user to hold the device 1, or to protect the components inside the case assembly 120.

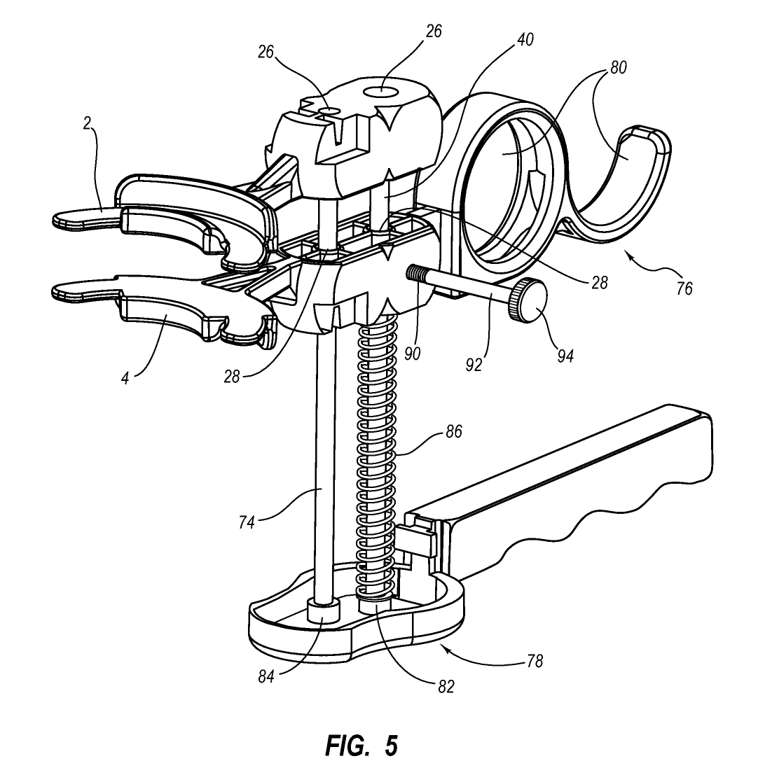

FIGS. 5 through 8 illustrate further embodiments of the present invention having various vertical elements, connecting assemblies, and positioning assemblies. These embodiments are shown in configurations that are non-exclusive. Various elements from these embodiments can be combined together, added to or subtracted from the tissue stretching device 1 to make further embodiments. To simplify the discussion, the case assembly has been removed from the drawings but it can be added to any embodiment discussed below.

FIG. 5 illustrates another embodiment of the tissue stretching device 1 with a positioning mechanism including a first handle 76 and a second handle 78. In this embodiment, a first handle 76 has been connected or formed as part of the mouthpiece 4 from the interface area 10. Fastened to the mouthpiece 2 with an element fastener 54 is the vertical element 40 of a bar or rod. The element 56 extends down through a shaped void 28 in the mouthpiece 4, and is held by an element catch 82 in the second handle 78. The first handle 76 shown in this embodiment has open and closed finger loops 80. The second handle 78 is shaped as an ergonomic beam. This figure also shows a support guide or supplementary support bar 74, which also is attached to the first or upper mouthpiece 2 and runs down through the second or lower mouthpiece 4 into a support catch 84 on the second handle 78. The supplemental support bar 74 is spaced from the elongate member 38 and connected to the raised body 34 of the mouthpieces 2 and 4 to guide the mouthpieces 2 and 4 relative to each other.

In the embodiment shown in FIG. 5, the first handle 76 and second handle 78 act as a positioning assembly, allowing users to wrap their hands around the handles. With force pushing the two handles together, the mouthpiece 4 can move down the vertical element 40 towards the second handle 78 to spread the mouthpieces 2 and 4 and if inserted to stretch the mouth and jaw open. In this illustration, the support bar 74 is one way to hold the mouthpieces vertically aligned with the bite areas over each other.

The positioning assembly 70 illustrated in FIG. 5 also shows a supplemental set screw structure that could also hold the second mouthpieces position. In this embodiment, a horizontal threaded bore 90 is positioned in its interface area of the mouthpiece 4 that is perpendicular to the shaped void and the vertical element. A fastener, such as set screw 92 with a set screw knob 94 is of a predetermined size to fit and thread through the horizontal threaded bore 90 to hit the vertical element 40. The embodiment shown in FIG. 5 also includes a compression structure, such as a spring 86 along the vertical element 40 between the mouthpiece 4 and the second handle 78. The tissue stretching device 1 can also include an expansion or compression structure, such as a spring, band, coil, or the like to force the mouthpieces 2 and 4 back together or apart after a user has completed a stretch exercise.

With this embodiment, the user loosens the set screw 92 from the shaped element 56 by turning the screw opposite to the threads of the bore, which releases the pressure from the screw on the element. The user can then manually press the first handle 76 toward the second handle 78 to position the mouthpieces in the user's mouth. When the desired position is achieved, the user can retighten the set screw 92 in the horizontal threaded bore 90, which puts force on the shaped element 56 to hold the mouthpiece 4 in place.

FIG. 5 also shows the use of a spring 86 or compression coil. This coil can be used on any of the devices and can provide upward pressure on the mouthpiece 4. This upward pressure can resist opening movement of the device 1, can act as a safety mechanism to help prevent over-stretching with the device 1, and can press the mouthpieces together for easy insertion, removal and storage. Alternatively, springs can be used between the two mouthpieces to provide a counteractive pressure pushing the mouthpieces apart and as a resistance exerciser for the muscles to close the mouth and jaw. Furthermore, an elastic or compressive band could be wrapped abound members of this device 1 to provide other pressures between the components.

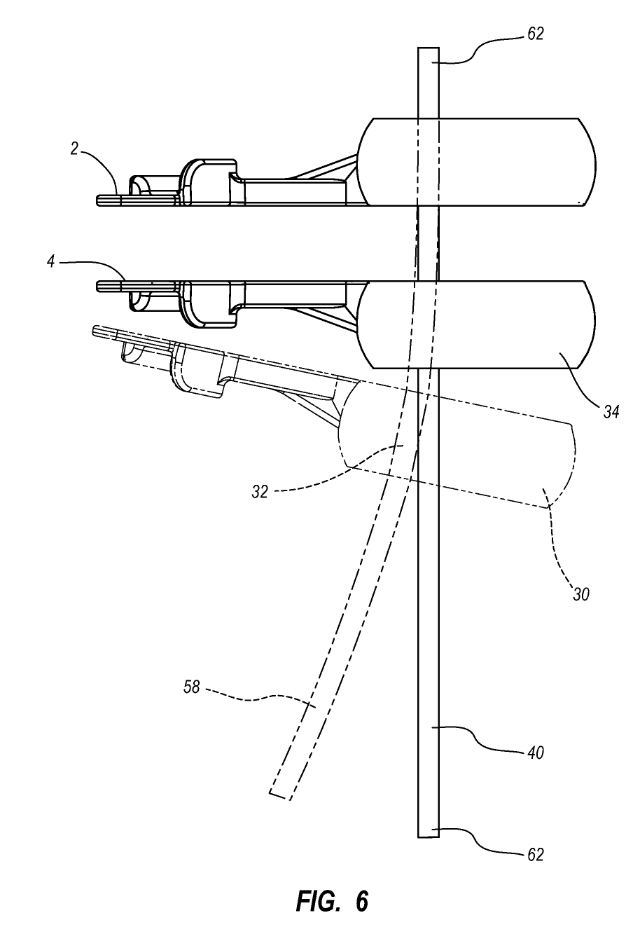

FIG. 6 illustrates another embodiment of the tissue stretching device 1 with a flexible or curved element 58 extending through a curved bore 32 in the mouthpiece 4. The use of a flexible or curved element 58 of predetermined shape or flexibility can be incorporated with any of the embodiments of the device 1 to help keep the mouthpieces firmly occluded against the upper and lower teeth, and to provide a more natural motion for the user as they open their mouth and the jaw with the invention. While FIG. 5 shows a vertical element 40 in a straight position, the embodiment in FIG. 6 is flexible or curved. When pressure bends a flexible member, it can curve to look like a curved element 58. The flexible or curved element can be a rod, beam, or bar made of a metal, plastic, composite, or similar material known by one skilled in the art to move a mouthpiece along a given path. The elongate member is shaped in a predetermined pattern to create a movement path for the first mouthpiece 2 or the second mouthpiece 4. The alternative position 30 of the second or lower mouthpiece 4 is illustrated to show how the mouthpiece can move with a curved member and a bending flexible member.

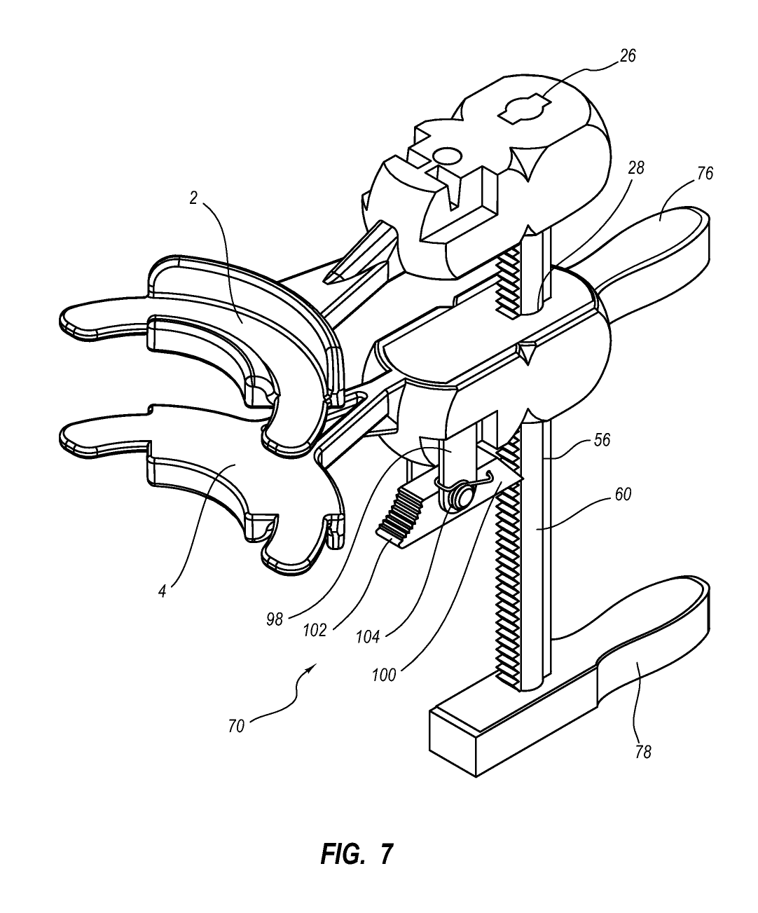

FIG. 7 shows an embodiment of the tissue stretching device 1 with a positioning assembly 70 that moves and positions the mouthpieces 2 and 4 with a ratchet mechanism assembly. This embodiment includes a vertical element having a notched element or bar 60 with a set of notches along at least one side of the vertical element. The bar is inserted and attached to the vertical element catch 26 on the first or upper mouthpiece 2, which could be fastened with an adhesive, clip, set screw, and/or pressure. On the bottom of the notched element 60 is a second handle 78. The mouthpiece 4 can include a first handle 76 formed in or attached to the interface area 10. A ratchet mechanism is attached to the mouthpiece 4. The shaped void 28 of the lower mouthpiece is slightly larger than the notched element 60. Extending out of the bottom of the mouthpiece 4 is a ratchet arm 98 that holds a hinged ratchet clip 100 connected to the second mouthpiece 4 and release 102 on torsion or spring hinge 104. The torsion hinge 104 holds the ratchet clip 100 against the notches of the notched element 60 to prevent the lower mouthpiece from sliding back toward the upper mouthpiece. Pressing the release 102, removes the ratchet clip 100 from the notched element 60 and allows the mouthpiece 4 to move along the notched element 60. Alternatively, the ratchet structure could also be incorporated into the raised body 34 of the lower mouthpiece. This figure also shows the elongate member as a non-circular shaped element 56 in a similarly matched shaped void 28 in the mouthpiece 4 that provides alignment of the mouthpieces.

In this embodiment, the user can use the device 1 to stretch the jaw by squeezing the first handle 76 and second handle 78 together. With this motion, the mouthpiece 4 slides along the notched element 60 with the ratchet mechanism clicking along the notches. When the user stops squeezing, the ratchet clip 100 pushes against the notches in the notched element 60 to hold the lower mouthpiece from moving back up and holds the mouthpiece in position to stretch user's mouth and jaw. For additional stretching, the user can further squeeze the handles together. When the patient is done stretching, the user presses the release 102 which pulls the clip away from the notches in the bar 69 allowing the mouthpiece to slide back toward the mouthpiece 2.

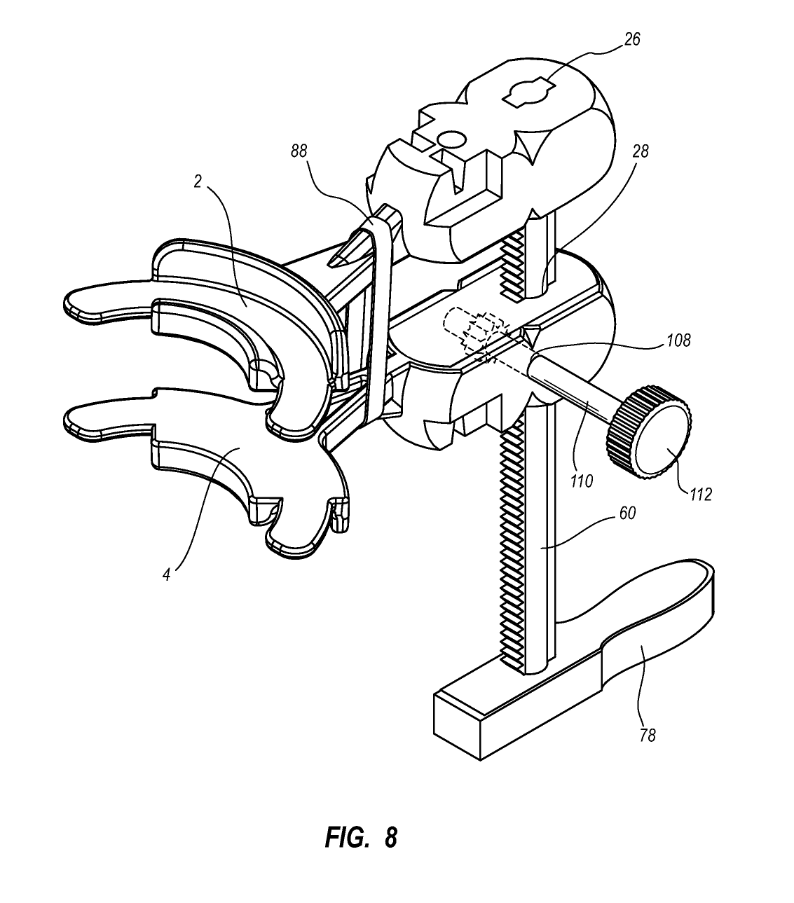

FIG. 8 shows a further embodiment of the tissue stretching device 1 with a positioning assembly that moves and holds position with a rack and pinion mechanism. In this embodiment, a notched element 60 with a second handle 78 is attached to the mouthpiece 2 in an element assembly. The mouthpiece 4 has a shaped void 28 sized larger than the bar. In addition, the mouthpiece 4 has a horizontal bore 108 cut or formed into the interface area and positioned to line up next to the notches of the notched element 60. A pinion gear 110 having a predetermined shape to match the notched element 60 and having a pinion knob 112 is inserted into the horizontal bore 108. Additionally, a supplemental compression band 88 is wrapped around the mouthpieces and can pull them towards each other. The positioning assembly in this embodiment is made up of the pinion gear 110, the pinion knob 112, the horizontal bore 108, and the notched element 60. To use this embodiment, the user turns the pinion knob 112 to rotate the pinion gear 110 which rolls along the rack of notches of the bar and moves the second or lower mouthpiece 4 up or down the bar to increase or decrease the distance from the first or upper mouthpiece 2 to stretch a user's jaw tissues. Friction from a tight horizontal bore, a fastener, or other component could be used to hold the pinion in position, to keep it from spinning or to hold the mouthpiece in place.

In accordance with the invention, a tissue stretching device 1 is provided that can be used like a static splint to perform sustained stretching of a user's mouth to allow the user's body to adjust and tissue to elongate for opening or functioning. The device 1 can be used without support bars, and can be used with a case body, user control, the friction of the device, or shape of the vertical element and corresponding voids to hold the mouthpieces in alignment. Furthermore, the device is small and easy to use, carry and clean with a case assembly that protects the internal mechanisms. The device also can include indicia on the case assembly to show the distance that the mouthpieces are opened and provides a record of the maximum distance. Various embodiments of the device also provide an even stretch for both sides of the mouth with a bite area that spreads the pressure across the teeth to minimize discomfort. In various embodiments of the invention, no coordination or continuous pressure is needed from the user to maintain a sustained stretch at a controlled distance; however, a dynamic force like a spring can be used to press the mouthpieces apart or pull them together.

While the above description contains many specifics, these should not be construed as limitations on the scope of the invention, but as exemplifications of the various embodiments thereof. Many other ramifications and variations are possible within the teachings of the invention. For example, the case can be used as part of the connected element; the case can be of a different shape or size, the use of no surrounding case; the upper and lower mouthpieces may have unique upper and lower shapes; the mouthpieces may have different shapes than shown or be made of flexible materials; the mouthpieces could be removable from the device; the case or connecting member could be of a different shape; the linkage between the mouthpieces and the connecting member assembly could be like a rail or two tracks; and the device could utilize any other mechanisms for moving and/or holding the mouthpieces in place as known by one skilled in the art. Thus the scope of the invention should be determined by the appended claims and their legal equivalents, and not by the examples given.

The present invention may be embodied in other specific forms without departing from its spirit or essential characteristics. The described embodiments are to be considered in respects only as illustrative and not restrictive. The scope of the invention is, therefore, indicated by the appended claims rather than by the foregoing description. Changes which come within the meaning and range of equivalency of the claims are to be embraced within their scope.

What is claimed is:

1. A tissue stretching device, comprising:
a. a first and second mouthpiece, each including a bite area, an extension bar, and an interface area, the bite area being shaped to match the general curvature of a set of teeth, the interface area having a raised body, and the extension bar being positioned between the bite area and the interface area; and
b. a connecting assembly linked to the interface area of the first mouthpiece and the second mouthpiece and arranged to couple the first mouthpiece inline with the second mouthpiece, the second mouthpiece being positioned in an inverted position relative to the first mouthpiece to place the raised body of the first and second mouthpieces in opposing directions, the connecting assembly including an elongate member, and at least one of the first and second mouthpieces being able to be positioned along the elongate member relative to the other mouthpiece.

2. The device of claim 1, further comprising at least one raised retention structure on the bite area of at least one of the first mouthpiece and the second mouthpiece.

3. The device of claim 1, wherein the elongate member is shaped in a predetermined pattern to create a movement path for at least one of the first mouthpiece and the second mouthpiece.

4. The device of claim 1, further comprising a handle connected to an end of the elongate member.

5. The device of claim 4, further comprising at least one of a compression structure and an expansion structure connecting at least two of the first mouthpiece, second mouthpiece and the handle together.

6. The device of claim 1, wherein the interface area of the first and second mouthpieces and the connecting assembly include a friction fit structure.

7. The device of claim 6, wherein the friction fit structure includes threads formed along the elongate member and a knob placed on an end of the elongate member, the elongate member being threaded into the raised body of the second mouthpiece, the second mouthpiece being movable relative to the first mouthpiece when the knob is rotated.

8. The device of claim 1, further comprising a positioning assembly associated with at least one of the first and the second mouthpieces, and the elongate member to selectively maintain a desired position and move the first and second mouthpieces relative to each other.

9. The device of claim 8 further comprising a mouthpiece situating structure holding the first mouthpiece in place along the elongate member.

10. The device of claim 8, wherein the positioning assembly is a fastener and the second mouthpiece is held in a desired position when the fastener is tightened against the elongate member.

11. The device of claim 8, wherein the positioning assembly includes a ratchet mechanism, the ratchet mechanism having a set of notches formed along the elongate member and a hinged ratchet clip connected to the second mouthpiece.

12. The device of claim 1, further comprising a rack and pinion mechanism, the rack and pinion mechanism having a set of notches formed along the elongate member and a pinion connected to the second mouthpiece to hold the pinion against the notches of the elongate member.

13. The device of claim 1, further comprising a support guide spaced from the elongate member and connected to the raised body of the first and second mouthpieces to guide the first and second mouthpieces relative to each other.

14. The device of claim 1, further comprising a case assembly shaped to enclose at least a portion of the first and second mouthpieces and the connecting assembly.

15. The device of claim 14, wherein the case assembly includes a slot, a portion of the first and second mouthpieces extending out from the case assembly through the slot.

16. The device of claim 15, wherein the slot is arranged to guide the first and second mouthpieces relative to each other.

17. The device of claim 14, further comprising indicia placed on the case assembly and spaced to provide a measurement of a distance between the first and second mouthpieces.

18. The device of claim 17, further comprising a position marker attached to the second mouthpiece and placed to extend over a portion of the indicia to gage the distance.
